(19) United States
(12) Patent Application Publication
(10) Pub. No.: US 2014/0183852 A1
(43) Pub. Date: Jul. 3, 2014

(54) Cover Assembly

(71) Applicant: Mehri Mafi, (US)

(72) Inventors: Mehri Mafi, San Jose, CA (US); Maryam Mafi, San Jose, CA (US)

(21) Appl. No.: 14/100,395

(22) Filed: Dec. 9, 2013

Related U.S. Application Data
(60) Provisional application No. 61/797,539, filed on Dec. 10, 2012.

(51) Int. Cl. B42D 3/02

(52) U.S. Cl. CPC B42D 3/02
USPC 281/31

(57) ABSTRACT

A cover assembly joins with a book to enable a sheet to display from the book, and to provide protection to the sheets within the book. The book includes a check book. The sheet slides between a transparent upper cover and a transparent lower cover through a sheet reception portion. The sheet orients in a direction by which an image or text on the sheet is visible through one of the covers. The upper cover and the lower cover join at a cover binding end that pivotally opens and closes the covers in conjunction with a book binder. The cover assembly includes a preprinted ornamental portion that forms a perimeter frame for the sheet and contains a theme. The cover assembly overlays the outer cover of the book, not affecting the functionality of the book or a plurality of book sheets inside the book.

### CROSS-REFERENCE TO RELATED APPLICATIONS

The present Utility patent application claims priority benefit of the U.S. provisional application for patent Ser. No. 61/797,539 titled “Design Cover for Checkbook,” filed on Dec. 10, 2012 under 35 U.S.C. 119(e). The contents of this related provisional application are incorporated herein by reference for all purposes to the extent that such subject matter is not inconsistent herewith or limiting hereof.

### RELATED CO-PENDING U.S. PATENT APPLICATIONS

Not applicable.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to a cover assembly. More particularly, the invention relates to a cover assembly that joins with a book to enable a sheet to display from the book, and to provide protection to the sheets within the book.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, another aspect of the prior art generally useful to be aware of is that a book is a handwritten or printed document on sheets of paper fastened or bound together within covers.

Often, a check book is a rectangular book configured to retain checks in the form of a book. The check book may have a rubber, plastic material for protecting the checks from moisture. The check book is sufficiently smooth to slide into a pocket or purse for storage.

Typically, a picture is a group of colored points on a flat surface that looks the same as something else. For example, a picture can look the same as an object or a person. Pictures can also be drawings, paintings or photographs. A picture can be portrayed on a check book to help with identification purposes, or just for decorative effects.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates a top view of an exemplary cover assembly joined with an exemplary book in an open position and displaying a sheet of an image, in accordance with an embodiment of the present invention.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

Headings provided herein are for convenience and are not to be taken as limiting the disclosure in any way.

The enumerated listing of items does not imply that any or all of the items are mutually exclusive, unless expressly specified otherwise.

The terms “a”, “an” and “the” mean “one or more”, unless expressly specified otherwise.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

Those skilled in the art will readily recognize, in light of and in accordance with the teachings of the present invention, that any of the foregoing steps may be suitably replaced, reordered, removed and additional steps may be inserted depending upon the needs of the particular application. Moreover, the prescribed method steps of the foregoing embodiments may be implemented using any physical and/or hardware system that those skilled in the art will readily know is suitable in light of the foregoing teachings. For any method steps described in the present application that can be carried out on a computing machine, a typical computer system can, when appropriately configured or designed, serve as a computer system in which those aspects of the invention may be embodied. Thus, the present invention is not limited to any particular tangible means of implementation.

The present invention will now be described in detail with reference to embodiments thereof as illustrated in the accompanying drawings.

There are various types of cover assemblies that may be provided by preferred embodiments of the present invention. In one embodiment of the present invention, the cover assembly may join with a book to enable a sheet to display from the book, and to provide protection to a plurality of sheets within the book. The book may include, without limitation, a check book, a notebook, a binder, and a picture book. The cover assembly may at least partially encapsulate the outer cover of the book, not affecting the functionality of the book or a plurality of book sheets inside the book. The sheet may slide between a pair of partially transparent covers, orienting in a direction by which an image or text may be visible through one of the covers. The sheet may include, without limitation, an image, a picture, a design, and text. The cover assembly may also include a preprinted ornamental portion that forms a perimeter frame for the sheet and contains a theme, such as birthdays, holidays, anniversaries and the like.

In one embodiment of the present invention, the cover assembly may include a lower cover and an upper cover. Each cover may be at least partially transparent for enabling the sheet to display between the respective covers. In some embodiments, the sheet may slidably enter between the lower cover and the upper cover through a sheet reception portion. The sheet reception portion may include a slot configured to at least partially receive the sheet. The sheet may overlay a plurality of book sheets. The lower cover may be pivoted along the cover binding end to enable the display of the plurality of sheets. The lower cover and the upper cover may join at a cover binding end. The cover binding end may join with a book binder so as to pivotally open and close in conjunction with the book. In some embodiments, the upper cover may include an ornamental portion that forms a frame around the sheet. The ornamental portion may include, without limitation, a themed design, graphic, color, and pattern that is preprinted onto the upper cover.

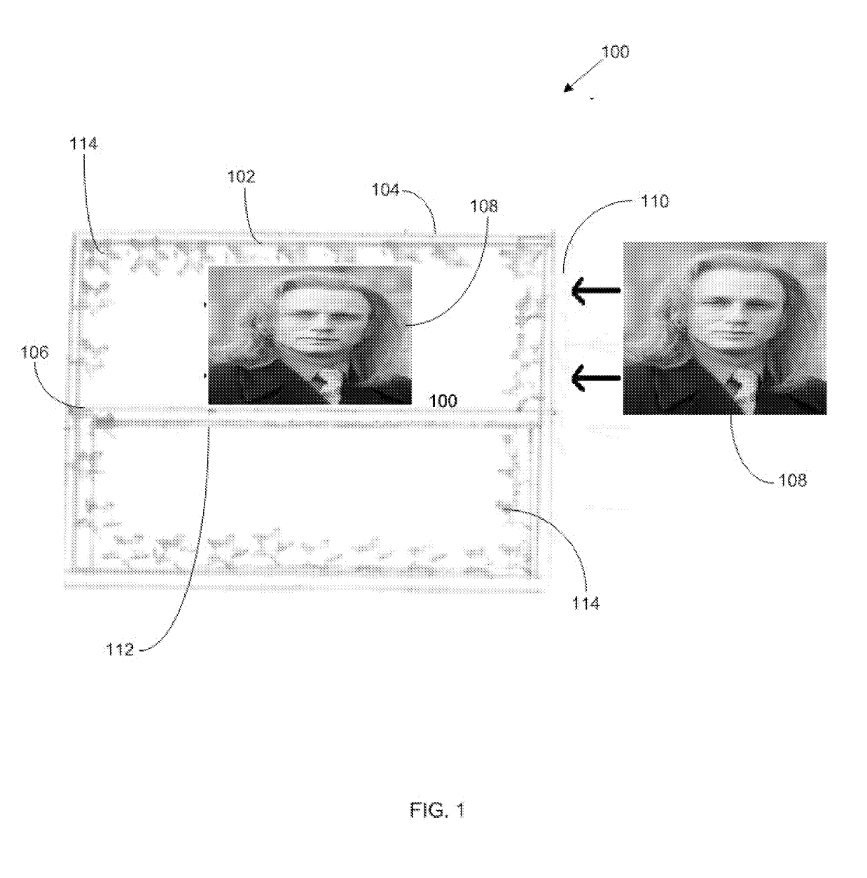

FIG. 1 illustrates a top view of an exemplary cover assembly joined with an exemplary book in an open position and displaying a sheet of an image, in accordance with an embodiment of the present invention. In the present invention, a cover assembly 100 may join with a book to enable a sheet to display from the book, and to provide protection to a plurality of sheets within the book. The book may include, without limitation, a check book, a notebook, a binder, and a picture book. The cover assembly may at least partially encapsulate the outer cover of the book, not affecting the functionality of the book or a plurality of book sheets inside the book.

In some embodiments, the cover assembly may be sized and dimensioned to join with any sized book. Suitable materials for the cover assembly may include, without limitation, plastic, polyurethane, rubber, cardboard, and card stock. In one embodiment, the sheet may slide between a pair of partially transparent covers, orienting in a direction by which an image or text may be visible through one of the covers. The cover assembly may also include a preprinted ornamental portion that forms a perimeter frame for the sheet and contains a theme, such as birthdays, holidays, anniversaries and the like. However, in other embodiments, a user may create a personalized ornamental portion, labeling the appropriate cover with the desired graphics and text.

In one embodiment of the present invention, the cover assembly may include a lower cover 104 and an upper cover 102. Each cover may be at least partially transparent for enabling a sheet 108 to display between the respective covers. The transparent cover may include a plastic flap having sufficient flexibility to bend in conjunction with a check book. The sheet may include, without limitation, an image, a picture, a design, and text. In one embodiment, the sheet may include a personalized picture of a user. In one alternative embodiment, a digital image may be utilized, whereby the sheet is a display screen. In some embodiments, the sheet may slidably enter between the lower cover and the upper cover through a sheet reception portion 110. A fastener may also be utilized to secure the sheet between the covers. The fastener may include, without limitation, an adhesive, a button, and a hook and loop fastener. The sheet reception portion may include a slot configured to at least partially receive the sheet. The sheet may overlay a plurality of book sheets 112. The lower cover may be pivoted along the cover binding end to enable the display of the plurality of sheets. The lower cover and the upper cover may join at a cover binding end 106. The cover binding end may join with a book binder so as to pivotally open and close in conjunction with the book. In some embodiments, the upper cover may include an ornamental portion 114 that forms a frame around the sheet. The ornamental portion may include, without limitation, a themed design, graphic, color, and pattern that is preprinted onto the upper cover. Suitable themes may include, without limitation, Christmas, Valentine's Day, birthdays, Halloween, marriages, graduations, and births.

In one alternative embodiment, the cover assembly may join with a text book for interchangeably displaying pictures. In yet another alternative embodiment, the upper cover may not be transparent, but includes a window for the image on the sheet to display through. In yet another alternative embodiment, the ornamental portion is a digital display showing a perpetually changing image.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA law 35 USC §112 (1), all claims must be supported by sufficient disclosure in the present patent specification, and any material known to those skilled in the art need not be explicitly disclosed. However, 35 USC §112 (6) requires that structures corresponding to functional limitations interpreted under 35 USC §112 (6) must be explicitly disclosed in the patent specification. Moreover, the USPTO's Examination policy of initially treating and searching prior art under the broadest interpretation of a “mean for” claim limitation implies that the broadest initial search on 112(6) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC §112 (6) when such corresponding structures are not explicitly disclosed in the foregoing patent specification. Therefore, for any invention element(s)/structure(s) corresponding to functional claim limitation(s), in the below claims interpreted under 35 USC §112 (6), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC §112 (6) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC §112 (6), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC §112 (6). Applicant(s) note that all the identified documents above which are incorporated by reference to satisfy 35 USC §112 (6) necessarily have a filing and/or publication date prior to that of the instant application, and thus are valid prior documents to incorporated by reference in the instant application.

Having fully described at least one embodiment of the present invention, other equivalent or alternative methods of joining a cover assembly to a book to slidably and interchangeably display a picture in the book according to the present invention will be apparent to those skilled in the art. Various aspects of the invention have been described above by way of illustration, and the specific embodiments disclosed are not intended to limit the invention to the particular forms disclosed. The particular implementation of joining a cover assembly to a book to slidably and interchangeably display a picture in the book may vary depending upon the particular context or application. By way of example, and not limitation, joining a cover assembly to a book to slidably and interchangeably display a picture in the book described in the foregoing were principally directed to a pair of covers that overlayed a check book, and allowed entry of a picture inside the check book implementations; however, similar techniques may instead be applied to attaching pictures or text into different types of books other than check books, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. An assembly comprising:
an upper cover, said upper cover being at least partially transparent, said upper cover comprising an ornamental portion;
a lower cover, said lower cover being at least partially transparent, said lower cover being disposed to join with said upper cover at a cover binding end, said cover binding end being disposed to join with a book at a book binder; and
a sheet, said sheet being configured to at least partially enter between said upper cover and said lower cover through a sheet reception portion, said sheet comprising an image and/or a text, said image and/or text being configured to display through said upper cover and/or said lower cover.

2. The assembly of claim 1, in which said book comprises a check book.

3. The assembly of claim 2, in which said upper cover comprises a transparent plastic flap.

4. The assembly of claim 3, wherein said ornamental portion is configured to form a frame around said upper cover.

5. The assembly of claim 4, in which said ornamental portion comprises a themed design.

6. The assembly of claim 5, in which themed design comprises a holiday, and/or a birthday, and/or an anniversary.

7. The assembly of claim 6, in which said lower cover comprises a transparent plastic flap.

8. The assembly of claim 7, in which said sheet comprises a picture.

9. The assembly of claim 8, in which said sheet reception portion comprises a slot.

10. The assembly of claim 9, in which said picture is disposed to display through said upper cover.

11. A assembly comprising:
means for joining an upper cover and a lower cover to a book through a cover binding end;
means for enabling at least partially entry of a sheet between said upper cover and said lower cover;
means for displaying said sheet through said upper cover;
means for displaying an ornamental portion on said upper cover; and
means for pivotally opening and/or closing said book and said assembly in conjunction.

12. An assembly consisting of:
an upper cover, said upper cover being at least partially transparent, said upper cover comprising a transparent plastic flap, said upper cover comprising an ornamental portion, said ornamental portion being configured to form a frame around said upper cover, said ornamental portion comprising a themed design, themed design comprising a holiday, and/or a birthday, and/or an anniversary;
a lower cover, said lower cover being at least partially transparent, said lower cover being disposed to join with said upper cover at a cover binding end, said cover binding end being disposed to join with a book at a book binder; and
a sheet, said sheet comprising a picture, said sheet being configured to at least partially enter between said upper cover and said lower cover through a sheet reception portion, said sheet reception portion comprising a slot, said sheet comprising an image and/or a text, said image and/or text being configured to display through said upper cover and/or said lower cover.
